(19) United States
(12) Patent Application Publication
(10) Pub. No.: US 2022/0339723 A1
(43) Pub. Date: Oct. 27, 2022

(54) MACHINE TOOL FOR MACHINING TEETH, METHOD FOR MACHINING TOOTH FLANKS OF A WORKPIECE, AND METHOD FOR DRESSING A TOOL FOR MACHINING TEETH USING A MACHINE TOOL OF THIS TYPE

(71) Applicant: REISHAUER AG, Wallisellen (CH)

(72) Inventor: Michel MÜLLER, Uster (CH)

(73) Assignee: REISHAUER AG, Wallisellen (CH)

(21) Appl. No.: 17/760,595

(22) PCT Filed: Sep. 4, 2020
(86) PCT No.: PCT/EP2020/074836

§ 371 Date: Mar. 15, 2022

(30) Foreign Application Priority Data
Sep. 16, 2019 (CH) 01169/19

(51) Int. Cl. B23F 1/02; B23F 19/00; B23F 23/00; B23F 5/04; B23F 9/02

(52) U.S. Cl. CPC B23F 1/023; B23F 19/002; B23F 23/006; B23F 5/04; B23F 9/02

(57) ABSTRACT

A machine tool (1) for processing gears comprises a workpiece spindle (16) for driving a workpiece (18) to rotate about a workpiece axis (C1), and a tool spindle (11) for driving a tool (12) to rotate about a tool axis (B). An axial slide (7) is used to change a relative axial feed position between the tool spindle and the workpiece spindle with respect to the workpiece axis. The axial slide is guided along an axial guide direction (Z′) which is inclined with respect to the workpiece axis by an inclination angle (ψ), the inclination angle (ψ) being between 0.1° and 30°.

### CROSS REFERENCE TO RELATED APPLICATIONS

This application is a National Stage of International Application No. PCT/EP2020/074836 filed on Sep. 4, 2020, claiming priority based on Swiss Patent Application No. 01169/19 filed on Sep. 16, 2019.

### TECHNICAL FIELD

The present invention relates to a machine tool for the machining of gears, a method for its operation, a computer program for carrying out the method and a computer-readable medium on which the computer program is stored.

### PRIOR ART

In gear manufacturing technology, straight or helical gears are often produced whose flank lines are modified by crowning. The magnitude of the modifications is often only in the range below a few tens of micrometers. Gears modified in this way have particular advantages with regard to load behavior and noise generation.

For the production of crowned gears, a prior-art process has been proposed in which the center distance between workpiece and tool is continuously changed along a radial infeed direction during a machining stroke. Specifically, it was proposed in the prior art to perform a movement along the radial infeed direction during the machining stroke that first increases the center distance, comes to a stop in the middle of the gearing and then reduces the center distance again while the tool is continuously advanced parallel to the workpiece axis.

This process is problematic in that the direction of the radial infeed movement is reversed during the machining stroke. The radial infeed movement involves a multitude of components between which elastic and frictional forces occur. When the direction is reversed, a transition from sliding friction to static friction takes place, particularly at the seals involved. As a result, after the change of direction, the static friction must first be overcome before sliding friction sets in again. In consequence, the radial infeed movement at the reversal point cannot completely follow the desired specifications and comes to a complete standstill for a certain period of time until the acting forces overcome the static friction force again. This effect can lead to undesired deviations of the flank shape from the specifications.

Especially in finishing operations where only a very small allowance is removed, the machining forces may be relatively small. This can lead to a load change when the radial infeed direction is reversed, which leads to an additional undesirable reversal effect due to the finite stiffness of the components involved.

In addition, frictional effects can occur for very slow radial infeed movements, even independently of direction reversal, which, together with elastic forces, can lead to friction-induced vibrations. Such effects also occur in the production of other modifications than crowned modifications, e.g. conical modifications.

These effects can be counteracted by various measures. In particular, special low-friction guide and drive components can be used to reduce the friction effects. To reduce the reversal effects, the rigidity of the guide and drive components can be increased or optimized together with the damping. Finally, these effects can also be counteracted by control algorithms. However, all these measures only lead to a mitigation of the problems mentioned above, but cannot completely eliminate them.

DE 10 2012 016515 A1 discloses a gear shaping machine whose shaping head slide is mounted on a machine stand in an inclined manner. In this way, a displacement in vertical direction causes a simultaneous displacement of the shaping tool in horizontal direction in order to lift the shaping tool from the workpiece during the return stroke. The generation of modifications is not addressed.

US 2016/176010 A1 discloses a generating gear grinding machine with two workpiece spindles and one tool spindle. The tool spindle is mounted slidably along a linear guide extending parallel to an inclined axis in the horizontal plane. The workpiece spindles are arranged at the same horizontal distance from the horizontal inclined axis. In a horizontal projection, the tool rotation axis forms an acute angle to the horizontal inclined axis. This prevents collisions between the tool spindle and the workpieces. The generation of modifications is not addressed here either.

### SUMMARY OF THE INVENTION

It is an object of the present invention to provide a gear manufacturing machine which enables the production of modified tooth flanks with higher precision.

A machine tool for machining gears is proposed. The machine tool comprises:
a workpiece spindle for driving a workpiece to rotate around a workpiece axis;
a tool spindle for driving a tool (machining tool) to rotate about a tool axis, and
an axial slide with which a relative axial feed position between the tool spindle and the workpiece spindle can be varied with respect to the workpiece axis.

According to the invention, the axial slide is guided along an axial guide direction which is inclined by an angle of inclination with respect to the workpiece axis. The angle of inclination has a value between 0.1° and 30°, preferably between 0.1° and 15°, especially preferably between 0.1° and 3°. In some embodiments, the angle of inclination has a value between 0.5° and 30°, between 0.5° and 15°, or between 0.5° and 3°.

The axial slide carries either the workpiece spindle or the tool spindle. Due to the inclined guidance of the axial slide, the radial distance between the tool axis and the workpiece axis changes when the axial slide moves along the axial guidance direction. This makes it possible to produce gears with flank line modifications without having to reverse the direction of the radial infeed movement during the machining of the gear. This avoids the problems mentioned above, which arise when the direction is reversed. Furthermore, it is possible to produce even the smallest flank line modifications without disturbing friction effects.

Preferably, the machine tool comprises an infeed slide with which the center distance between the tool axis and the workpiece axis can be additionally changed along an infeed direction. This infeed movement can be performed independently of the movement along the axial guide direction. It is superimposed on the change of the center distance due to the inclined guidance of the axial slide. During the machining of the tooth flanks, simultaneous movements of the axial slide and the infeed slide take place accordingly.

The infeed direction can be, but does not have to be, perpendicular to the workpiece axis. In the following, it will be referred to as “radial infeed direction”, even if this direction is not necessarily exactly radial to the workpiece axis, i.e. not necessarily exactly perpendicular to the workpiece axis. For example, the radial infeed direction can form an angle with the workpiece axis in the range from 60° to 120°.

The axial guide direction preferably runs in a common plane with the workpiece axis and the radial infeed direction. The inclination angle in this plane can be positive or negative, i.e. the axial guide direction can be inclined away from or towards the workpiece axis (as viewed from the machine bed).

Preferably, the tool spindle is arranged directly or indirectly (i.e. via further slides and/or swivel bodies) on the axial slide, i.e. the tool spindle executes movements along the inclined axial guide direction relative to a machine bed of the machine tool. In this case the axial slide forms a tool carrier. However, it is also conceivable that the workpiece spindle is mounted directly or indirectly on the axial slide, i.e. that the workpiece spindle executes movements along the inclined axial guide direction relative to the machine bed.

In particular, the following sequence of axes can be present: The infeed slide can be guided on the machine bed so as to be displaceable along the radial infeed direction and form a tool carrier, and the axial slide can then be arranged on the infeed slide so as to be guided along the axial guide direction.

In advantageous embodiments, the tool spindle is configured to be swiveled around a swivel axis relative to the axial slide. For this purpose, the machine tool can comprise a swivel body. In particular, the swivel body can be arranged on the axial slide. If the tool is a grinding tool, the swivel body is also called a grinding head. The swivel axis preferably runs parallel to the radial infeed direction or perpendicular to the workpiece axis. However, it can also run at an angle to the radial infeed direction that deviates from 0°, wherein this angle preferably has an absolute value between 0° and 30°. The swivel axis can also run at an angle to the workpiece axis that deviates from 90°, wherein this angle is preferably in the range of 60° to 120°. In particular, the swivel axis can run perpendicular to the axial guide direction. It is advantageous if the swivel axis lies in a plane that is spanned by the workpiece axis and the axial guide direction.

In an embodiment that is particularly suitable for continuous generating grinding, the tool spindle can be moved relative to the axial slide along a shift direction that is parallel to the tool axis. For this purpose, the machine tool can comprise a shift slide. In particular, the shift slide can be mounted on the swivel body in such a way that it can be moved relative to the swivel body along the shift direction. The shift direction is preferably perpendicular to the swivel axis around which the tool spindle can be swiveled. In some embodiments it is also perpendicular to the radial infeed direction.

The present invention also provides a method for machining tooth flanks of a workpiece with a machine tool of the type indicated above. The method comprises:
carrying out a machining stroke by carrying out a movement between the tool spindle and the workpiece spindle along the inclined axial guide direction while a tool mounted on the tool spindle is in machining engagement with the workpiece mounted on the workpiece spindle; and
carrying out an infeed movement between the tool spindle and the workpiece spindle along a radial infeed direction simultaneously with the machining stroke,
wherein the movement along the inclined axial guide direction is carried out at an axial guide speed and the movement along the radial infeed direction is carried out at a radial infeed speed.

Accordingly, the machine preferably comprises a control device that is designed to control the machine tool in such a way that it carries out corresponding simultaneous movements between the tool spindle and the workpiece spindle along the inclined axial guide direction and the radial infeed direction.

Preferably the sign of the axial guide speed does not change during a machining stroke. Also the sign of the radial infeed speed preferably does not change during a machining stroke. It is advantageous if the radial infeed speed during a machining stroke (and thus during the machining of each individual tooth flank) does not fall below a predetermined threshold value. This prevents negative effects during the radial infeed movement. As a result, flank line modifications can be manufactured with much greater accuracy than in the prior art.

Particular advantages are obtained if the radial infeed speed and the axial guide speed have a ratio that changes over time. In particular, these speeds can have such a variable ratio that the radial infeed speed does not change its sign during a machining stroke (and thus during the machining of a tooth flank), while a resulting movement between the tool spindle and the workpiece spindle along the radial infeed direction has a speed that changes its sign during the machining of the tooth flanks (or during a machining stroke). This allows the production of gearings modified in particular by width crowning, without the above-mentioned disadvantages of the prior art.

The method can comprise:
measuring position variables along the radial infeed direction and the inclined axial guide direction; and
transforming the measured position variables into transformed position variables along the radial infeed direction and an axial feed direction that is parallel to the workpiece axis.

The method can also comprise:
generating control commands for a movement of the tool spindle relative to the workpiece spindle along an axial feed direction parallel to the workpiece axis; and
transforming the generated control commands into transformed control commands for simultaneous movement of the tool spindle along the inclined axial guide direction and the radial infeed direction.

These measures make it possible to control the machine with a controller designed for machines whose axial guide direction is parallel to the direction of the workpiece axis.

The control device of the machine tool can accordingly comprise at least one of the following transformation devices:
a first transformation device for transforming position variables measured along the radial infeed direction and the inclined axial guide direction into transformed position variables along the radial infeed direction and an axial feed direction that is parallel to the workpiece axis; and
a second transformation device for transforming control commands for a movement of the tool spindle relative to the workpiece spindle along an axial feed direction parallel to the workpiece axis into transformed control commands for a simultaneous movement of the tool spindle along the inclined axial guide direction and the radial infeed direction.

In particular, the machine tool can be configured for carrying out one of the following processes: continuous generating grinding, discontinuous generating grinding, discontinuous or continuous profile grinding, gear honing, hobbing or hob peeling (gear skiving). For this purpose, an appropriate tool can be clamped on the tool spindle. The control device can be configured to control the machine tool in such a way that it executes the movements of the tool spindle and the workpiece spindle that are typical for the respective process.

The machine tool can comprise a dressing device with a dressing tool. The control device can then be configured to dress the tool, in particular a grinding worm, with the dressing tool, generating movements along the inclined axial guide direction during dressing. Dressing thus involves relative movements between the tool and the dressing tool along the inclined axial guide direction while the tool is in engagement with the dressing tool. In this way, similar advantages can be achieved in dressing as in gear machining.

In particular, the control device can be configured to align the tool spindle, using the associated swivel axis, relative to the axial slide in such a way that the tool axis is in or parallel to a plane that is spanned by the axial guide direction and the radial infeed direction. This orientation of the tool spindle is referred to in the following as the dressing orientation. The thus-defined selection of the dressing orientation is particularly advantageous if the tool is a grinding worm. During the dressing process, the grinding worm can in this way be readily moved along its longitudinal axis, i.e. along the tool axis, relative to the dressing tool by moving the grinding worm along the inclined axial guide direction in order to dress the grinding worm over its entire width. The axial slide can be used for this purpose. If the tool spindle is mounted on a shift slide, the shift slide can be used alternatively or additionally, depending on the embodiment.

The dressing device may include a dressing spindle designed to drive the dressing tool to rotate about a dressing spindle axis. The dressing spindle is preferably configured to be swiveled about at least one swivel axis to bring the dressing tool into engagement with the machining tool when the tool spindle is in the above-mentioned dressing orientation. For this purpose, the dressing device may comprise a corresponding swivel body. The swivel axis of the dressing spindle is preferably transverse to the axial feed direction, in particular at an angle of 60° to 120° to the axial feed direction, and transverse to the workpiece axis, preferably at an angle of 60° to 120° to the workpiece axis, in particular perpendicular to the latter. If the workpiece axis is vertical in space, the swivel axis of the dressing spindle is preferably horizontal.

The dressing device can be mounted on a movable tool carrier together with at least one workpiece spindle, or it can be arranged stationary relative to the machine bed.

The present invention also provides a computer program. The computer program comprises instructions which cause a control device in a machine tool of the type explained above, in particular one or more processors of the control device, to carry out the process explained above. The computer program may be stored in an appropriate memory device.

Furthermore, the invention provides a computer-readable medium on which the computer program is stored. The medium may be a non-volatile medium, for example a flash memory, a CD, a hard disk, etc.

### BRIEF DESCRIPTION OF THE DRAWINGS

Preferred embodiments of the invention are described in the following with reference to the drawings, which serve only for explanation and are not to be interpreted as limiting. In the drawings:

FIG. 1 shows a schematic perspective view of a generating gear grinding machine according to a first embodiment;

FIG. 2 shows a schematic side view of the generating gear grinding machine in FIG. 1;

FIGS. 3(a) and 3(b) show diagrams illustrating a coordinate transformation during the machining of a cylindrical gear;

FIG. 4 shows a schematic side view of a cylindrical gear having a gearing that is modified by crowning;

FIGS. 5(a) and 5(b) show diagrams illustrating a coordinate transformation when machining a cylindrical gear according to FIG. 4;

FIG. 6 shows a schematic block diagram of functional units for controlling the axial feed movement;

FIG. 7 shows a schematic side view of a generating gear grinding machine according to a second embodiment;

FIG. 8 shows a schematic side view of a generating gear grinding machine according to a third embodiment; and

FIG. 9 shows a schematic side view of a generating gear grinding machine according to a fourth embodiment.

### DESCRIPTION OF PREFERRED EMBODIMENTS

Exemplary Structure of a Generating Gear Grinding Machine

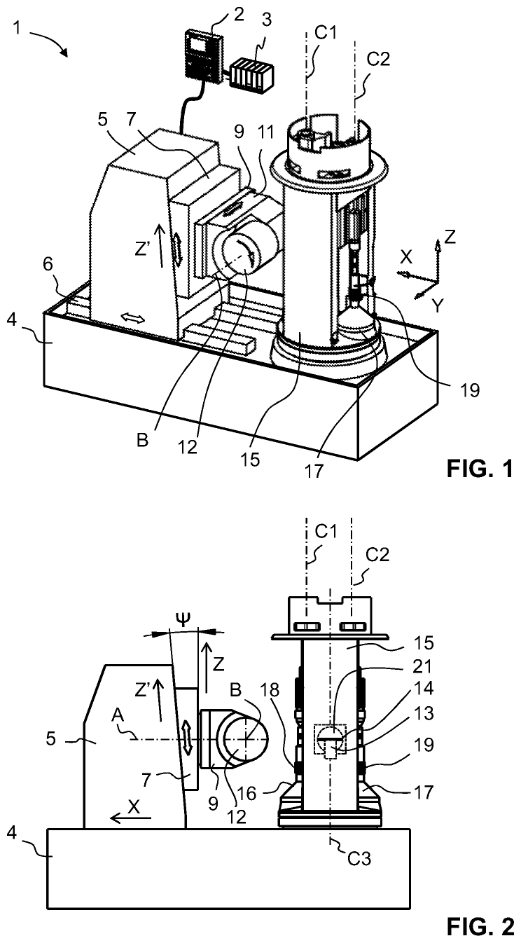

FIGS. 1 and 2 show a generating gear grinding machine 1 according to a first embodiment as an example of a machine tool for the machining of gears. The machine comprises a machine bed 4 on which a tool carrier 5 is guided along a radial infeed direction X by linear guides 6. The tool carrier 5 carries an axial slide 7, which is displaceably guided along an axial guide direction Z′ in relation to the tool carrier 5. A grinding head 9 is mounted on the axial slide 7, which can be swiveled about a swivel axis A running parallel to the X direction to adapt to the helix angle of the gear to be machined. The grinding head 9 in turn carries a shift carriage on which a tool spindle 11 is arranged to be moved along a shift direction Y. The shift direction Y runs perpendicular to the swivel axis A and therefore also perpendicular to the X direction, but not necessarily perpendicular to the Z′ direction. A finishing tool in the form of a worm-shaped grinding wheel (grinding worm) 12 is clamped on the tool spindle 11. The grinding worm 12 is driven by tool spindle 11 to rotate about a tool axis B. The tool axis B runs parallel to the Y direction.

The machine bed 4 also carries a swiveling workpiece carrier 15 in the form of a turret, which can be swiveled around a vertical axis C3 between at least two positions. Two identical workpiece spindles 16, 17 are mounted diametrically opposite each other on the workpiece carrier 15. The workpiece spindle 16 shown on the left in FIG. 2 is in a machining position in which a workpiece 18 clamped on it can be machined with the grinding worm 12.

For this purpose, this workpiece spindle drives workpiece 18 to rotate about a vertical first workpiece axis C1. The other workpiece spindle 17, which is offset by 180°, is in a workpiece change position in which a finished workpiece 19 can be removed from this spindle and a new blank can be clamped. The axis of the workpiece spindle located in this position is referred to as the second workpiece axis C2.

In addition, a dressing device 13, shown only schematically, with a dressing tool 14 is mounted on the turret. The dressing device 13 serves to dress the grinding worm 12.

All driven linear and rotary axes of the gear grinding machine 1 are digitally controlled by a machine control device with operator panel 2 and axis modules 3. Each axis module 3 provides control signals at its output for one machine axis (i.e. for at least one actuator used to drive the relevant machine axis, such as a servo motor).

Machining of a Workpiece

In order to machine an unmachined, pre-toothed workpiece (blank) 19, the workpiece 19 is clamped by an automatic workpiece changer on the workpiece spindle 17 that is in the workpiece change position. The workpiece is changed during the machining of another workpiece 18 on the other workpiece spindle 16, which is in the machining position. When the new workpiece 19 to be machined has been clamped and the machining of the other workpiece 18 has been completed, the workpiece carrier 15 is swiveled by 180° around the C3 axis so that the spindle with the new workpiece to be machined reaches the machining position. Before and/or during the swiveling operation, a meshing operation is performed with the aid of a meshing probe, not shown in the drawings, which is arranged on the workpiece carrier 15. For this purpose, the workpiece spindle 17 is set in rotation and the position of the tooth gaps of the workpiece 19 is measured with the help of the meshing probe. On this basis, the rolling angle is set.

When the workpiece spindle 17, which carries the workpiece 19 to be machined, has reached the machining position, the workpiece 19 is engaged with the grinding worm 12 by moving the tool carrier 5 along the X axis. The workpiece 19 is now machined by the rotating grinding worm 12 in rolling engagement. The machine executes coordinated movements along the X, Y and Z′ axes. Machining can be performed in one or more axial machining strokes. During each machining stroke, the machine executes a movement along the Z′ axis whose speed does not change its sign.

Parallel to the machining of the workpiece, the finished workpiece 18 is removed from the other workpiece spindle 16, and another blank is clamped on this spindle.

Axis Directions

In addition to the already mentioned directions X, Y and Z′, a further direction Z is defined. By definition, this direction is parallel to the workpiece axis C1, i.e. to the axis of rotation of the workpiece that is in the processing position. The machining stroke along the Z′ axis continuously changes the position of the tool relative to the workpiece along the Z direction during the machining of the workpiece in order to machine the gearing across the entire width of the workpiece. This is called axial feed, and the Z direction is therefore also called the axial feed direction.

In the prior art, the axial guide direction Z′, i.e. the direction along which the axial slide 7 is guided displaceably, usually coincides with the axial feed direction Z. In the present machine, however, these directions differ from each other. Specifically, the Z′ direction runs within a plane that is spanned by the X direction and the Z direction and is inclined at an angle ψ with respect to the Z direction. The absolute value of ψ is between 0.1° and 30°, in particular between 0.1° and 30°, preferably between 0.1° and 15°. A relatively small angle may be sufficient, e.g. between 0.1° and 3°, especially between 0.5° and 3°.

For the presently proposed arrangement of the directions X, Y, Z, Z′, A, B and C1, the following relationships hold:
X⊥Y, X⊥Z, Y∥Z
A∥X, B∥Y,C1∥Z
A⊥B, A⊥C1, B∥C1
Z′∥Z, Z′≮X, Z′ lies in X-Z or X-C1 plane

Here the symbol II means “is parallel to”, the symbol ∥ means “is not parallel to”, the symbol ⊥ means “is perpendicular to” and the symbol ≮ means “is at an angle unequal to 0° and unequal to 90°”.

Coordinate Transformation

The machine controller normally calculates, for a desired flank shape of the gearing, the corresponding control commands in the coordinate system X, Y, Z. In the present machine, a pure feed movement along the Z direction requires simultaneous movements along the X and Z′ directions. In order to be able to operate the present machine without having to rewrite all machine programs, the machine control device is advantageously designed in such a way that it transforms the usual feed commands for movements along the Z direction into transformed control commands for simultaneous movements along the X and Z′ directions.

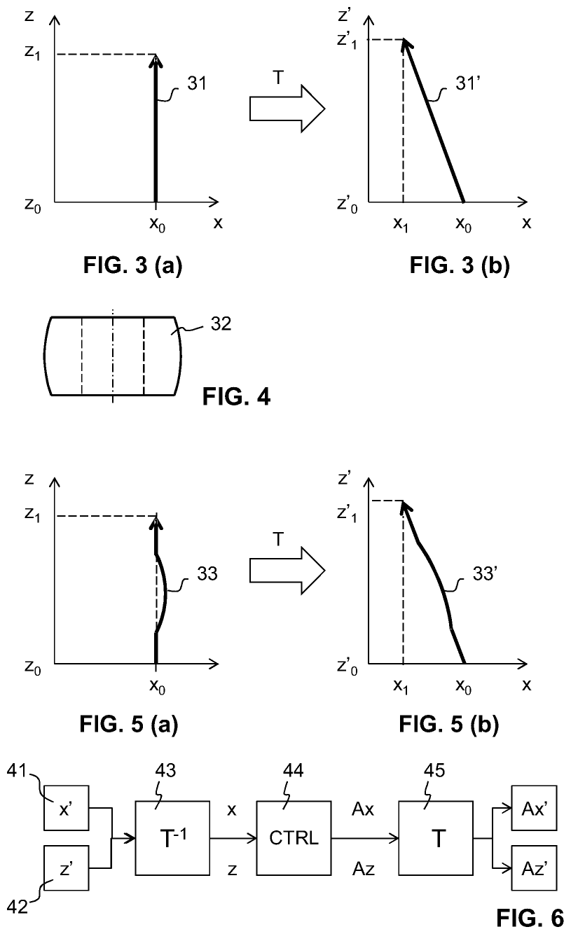

This is explained in the following with reference to FIG. 3. Let us assume that the tool moves at a constant speed v_{Z} along the Z direction and at a constant center distance to the workpiece from an initial position with coordinates x=x₀, z=z₀ to an end position with coordinates x=x₀, z=z₁. The corresponding motion profile 31 is illustrated in FIG. 3(a). Such a motion profile is selected if a cylindrical gear is to be machined without its flanks being modified by additional axis movements.

In order for such a motion profile to be generated in the present machine, the drives must be operated simultaneously along the X and Z′ directions. This is illustrated in f FIG. 3(b). As can be seen from this diagram, the axial slide 7 moves continuously along the positive Z′ direction, while the tool carrier 5 moves continuously in the negative X direction (i.e. to the right in FIG. 2) to compensate for the inclination of the axial guide direction Z′. Overall, the axial slide 7 is moved along the Z′ direction at constant speed from a location z′₀ to a location z′₁, while it is moved along the X direction at constant speed from location x₀ to location x₁. The following holds for the start and end positions:

z′₁−z′₀=(z₁−z₀)/cos ψ

x₁−x₀=−(z₁−zₒ)·tan ψ

Accordingly, the following holds for the speeds v′_{Z} along the Z′ direction and v_{X} along the X direction:

v′_{Z}=v_{Z}/cos ψ

vₓ=−v_{Z}·tan ψ

The corresponding motion profile 31′ along the X and Z′ directions is illustrated in FIG. 3(b).

On this basis, it is easily possible to transform feed commands along the Z direction into transformed feed commands along the X and Z′ directions.

If the tool simultaneously performs a shift movement along the Y-axis, this movement remains unaffected by the transformation to the X, Y, Z′ coordinate system. Also, e.g. a tilt movement around the A axis, if executed during machining, or a change of the rolling angle to generate additional rotary movements between workpiece and tool remain unaffected.

Assuming that the coordinate origins of the Z and Z′ directions coincide, spatial coordinates x, y, z in the coordinate system X, Y, Z can thus be transformed into spatial coordinates x′, y′, z′ in the coordinate system X, Y, Z′ as follows

x′=x−z tan ψ

y′=y

z′=z/cos ψ

The inverse transformation T⁻¹ is to be applied if measurements are made with a measuring system arranged along the X and Z′ directions and on the basis of such measurements the

X and Z coordinates of the axial slide 7 are to be determined. This inverse transformation may be necessary to provide the machine control with the measured coordinates in the required form. In this case the coordinates x, y, z in the coordinate system X, Y, Z are to be calculated as follows from the coordinates x′, y, in the coordinate system X, Y, Z′:

x=+x′+z′·sin ψ

y=y′

z=z′·cos ψ

Generation of a Crowned Modification

In the following, the generation of a crowned modification on a cylindrical gear is explained with reference to FIGS. 4 and 5.

A modified cylindrical gear 32 that is crowned along its width is shown symbolically in FIG. 4.

The teeth of the cylindrical gear are thicker along the width direction (during machining, this is the Z direction) in the center than at the ends, and the flank lines of the tooth flanks are curved accordingly. Sometimes, due to production reasons, the tip diameter is also larger in the center of the gear than at the ends, so that the gear also has a barrel-shaped outer contour. In FIG. 4, the barrel-shaped outer contour is drawn in an extremely exaggerated way to make the principle easier to explain. In reality, such modifications are usually only in the range of a few micrometers and are not visible to the naked eye.

It is known from the prior art to generate a crowned cylindrical gear by superimposing a slow radial infeed movement in X direction on the feed movement along the Z direction. Such a motion profile 33 is illustrated in FIG. 5(a). A uniform axial feed movement with constant speed along the Z direction is superimposed with an infeed movement along the X direction. The infeed movement initially has a positive speed (coordinate x increases), which decreases until the infeed speed in the center of the gear width becomes zero and changes its sign (i.e. coordinate x decreases again).

Very low radial infeed speeds are problematic due to the unavoidable friction effects. A reversal of the direction of the infeed movement is also problematic because the elements involved in the guide along the X-direction show an unavoidable reversal effect.

With the present machine, a reversal of the direction of the infeed movement is avoided when generating modifications, and the infeed speed never falls below a certain minimum speed during the machining of the gear teeth, provided the required amount of crowning is not too great. This is illustrated in FIG. 5(b), where the resulting motion profile 33′ is illustrated. The tool carrier 5 moves continuously in the negative X direction to compensate for the inclination of the Z direction. This continuous basic movement is superimposed with the movement to generate the modification. The speed of the superimposed movement is, however, always less than the speed of the basic movement, so that the direction is never reversed during the machining of the gearing and a certain minimum speed is never fallen below.

Functional Units for Controlling the Axial Feed Movement and Radial Infeed Movement

FIG. 6 schematically illustrates various functional units used to generate the axial feed movement along the Z direction and the radial infeed movement along the X direction. Position sensors 41, 42 detect the positions x′, z′ of the axial slide 7 along the X and Z′ directions. A first transformation device 43 transforms these positions in the coordinate system X, Y, Z′ into the positions x and z in the coordinate system X, Y, Z by applying the inverse transformation T⁻¹ and transfers these actual values to a control computer 44 of the machine controller. The control computer 44 generates control signals Ax, Az, which correspond to nominal values for the positions of the axial slide 7 in the coordinate system

X, Y, Z. A second transformation device 45 transforms these control signals into transformed control signals Ax′, Az′ in the coordinate system X, Y, Z′ and transfers these transformed control signals to the axis modules 3 of the machine controller.

Application During Dressing

It is known from the prior art to create modifications on the flanks of a grinding worm during dressing by means of corresponding axis movements in order to transfer these modifications to the workpiece flanks during the subsequent machining in a diagonal process. For this purpose it is known to bring a spatially fixed dressing device comprising a rotating dressing wheel into engagement with the grinding worm and to generate the necessary movements with the machine axes X and Y.

A different dressing strategy is possible with the present machine. For this dressing strategy, the grinding worm is swiveled around the A axis to such an extent that the shift axis Y and the tool axis B are vertical, i.e. run along the Z direction. The dressing device is also aligned accordingly.

FIG. 2 indicates the dressing device 13, which is only symbolically represented by the dashed line. The dressing device is mounted on the workpiece carrier (turret) 15. It can be brought into a position in which it is opposite the grinding worm 12 by swiveling the turret through 90°. The dressing device 13 comprises a dressing spindle with a dressing wheel 14 mounted on it and driven to rotate. The dressing spindle is mounted on a swivel body 21. The swivel body is connected to the workpiece carrier so that it can be swiveled in such a way that the dressing wheel 14 can be aligned in the direction of the worm threads and relative to the grinding worm profile. The corresponding swivel axis runs perpendicular to each workpiece axis C1, C2 and horizontally in space. In FIG. 2, the corresponding swivel axis runs perpendicular to the drawing plane. In addition, the dressing spindle can be swiveled about a further swivel axis which also runs horizontally in space and is perpendicular to the above swivel axis. In FIG. 2, this additional swivel axis runs horizontally in the drawing plane. This additional swivel axis can be used, for example, to change the profile angle during dressing.

The required dressing movements along the tool axis B are now generated with the axial slide 7 instead of the shift slide along the Y axis, as is usually the case. Similar considerations to those described above for workpiece machining apply here. In particular, it can be avoided in this way that a reversal of direction occurs along the X-direction when modifications are generated on the grinding worm flank.

Likewise, the present invention is advantageous when dressing is carried out by means of a gear-shaped dressing wheel mounted on the workpiece spindle.

Further Applications

The advantages of the present invention were explained above using the example of the production of crowned cylindrical gears. However, the invention is not limited to this application, but can also be used advantageously in the production of other gearings or gears. In particular, the invention also has advantages in the production of gearings modified in other ways, e.g. conically modified gearings, since the invention can also be used there to avoid disturbing frictional effects.

### Second Embodiment

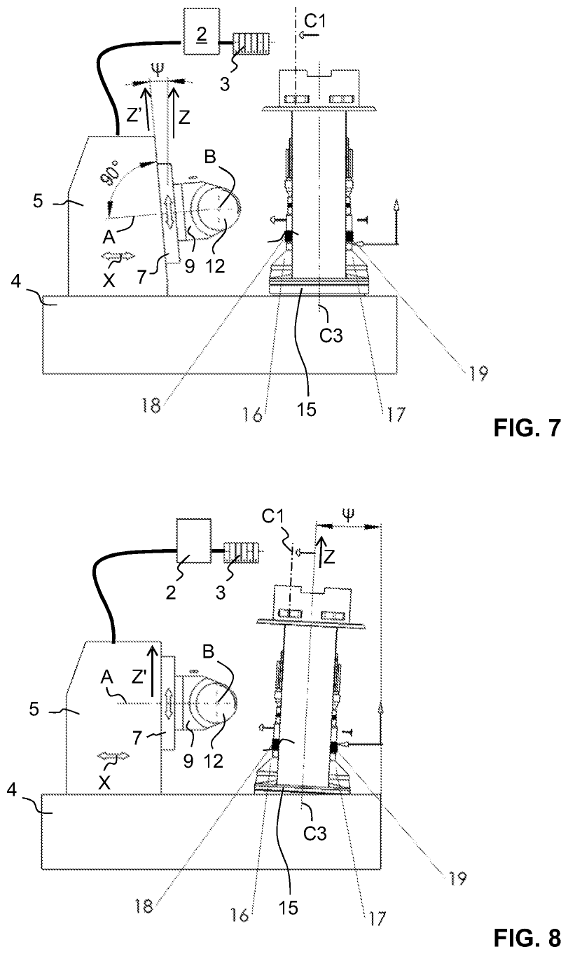

FIG. 7 schematically shows a generating gear grinding machine according to a second embodiment. This embodiment differs from the first embodiment in that the A axis is not perpendicular to the Z direction and parallel to the X direction, but perpendicular to the Z′ direction and accordingly at an angle 4i to the X direction. This means that the Y axis and the tool axis B are no longer perpendicular to the X direction as soon as the swivel angle around the A axis deviates from the position shown in FIG. 7. Nevertheless, the above-mentioned advantages can also be achieved with this arrangement. This embodiment is particularly suitable for small tilt angles between 0.1° and 3°.

All in all, the following applies to the arrangement of the directions X, Y, Z, Z′, A, B and C1 in this embodiment:
X≮Y, X⊥Z, Y∥Z
A≮X, B∥Y, B∥C1, C1∥Z
A⊥B, A⊥Y, A⊥Z′, A≮C1, A≮Z, A lies in X-C1 plane
Z′∥Z, Z′≮X, Z′ lies in X-Z or X-C1 plane

Due to the inclined A axis, further coordinate transformations are necessary compared to the first embodiment in order to get from a coordinate system defined by the machine axes X, Y, Z′, A, B, C1 into an orthogonal coordinate system or into a conventional coordinate system of the machine controller and vice versa. However, the corresponding transformations can easily be derived by simple trigonometric considerations.

### Third Embodiment

FIG. 8 schematically shows a generating gear grinding machine according to a third embodiment. In this embodiment, the entire tool carrier 5 including axial slide 7, shift slide and grinding head 9 is conventionally constructed. In particular, the axial guide direction Z′ is perpendicular to the infeed direction X. Instead, the workpiece carrier (turret) 15 is inclined relative to the vertical. As a result, the workpiece axis C1 in particular and thus also the axial feed direction Z, which by definition runs parallel to the workpiece axis C1, is no longer perpendicular to the X direction.

Also for this embodiment, further coordinate transformations are necessary compared to the first embodiment in order to get from a coordinate system defined by the machine axes X, Y, Z′, A, B, Cl into an orthogonal coordinate system or into a conventional coordinate system of the machine controller and vice versa. The corresponding transformations can again be easily derived by simple trigonometric considerations.

### Fourth Embodiment

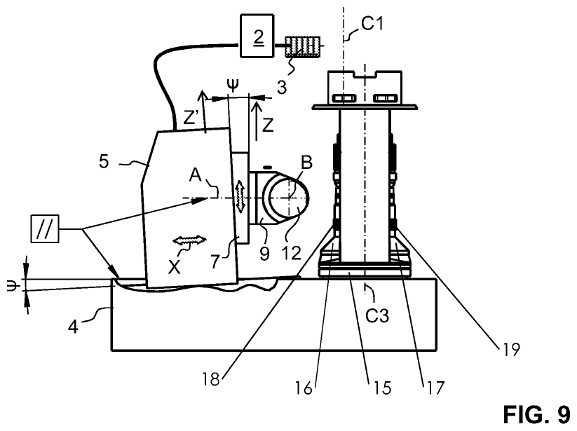

FIG. 9 schematically shows a gear grinding machine according to a fourth embodiment. As in the first and second embodiments, the turret with the axes C1 and C3 is positioned vertically in space, and the axial slide 7 is guided relative to the tool carrier 5 along an axial guide direction Z′, which is inclined relative to the workpiece axis C1 running vertically in space by an angle of inclination ψ to the vertical. However, unlike in the first and second embodiments, the entire tool carrier 5 together with the axial slide 7, the shift slide and the grinding head 9 is not guided exactly horizontally on the machine bed 4, but along a direction that is inclined to the horizontal by an angle of inclination ψ. As in the embodiments discussed above, the guidance direction is again referred to as the X direction. The X direction here is therefore not perpendicular to the Z direction, but perpendicular to the Z′ direction. As in the first embodiment, the A axis is horizontal in space and thus perpendicular to the Z direction. Because of the inclined X axis, the A axis is not parallel to the X-direction.

All in all, the following applies to the arrangement of the directions X, Y, Z, Z′, A, B and C1 in this embodiment:
X≮Y, X≮Z, Y∥Z
A≮X, B∥Y, B∥C1, C1∥Z
A⊥B, A⊥Y, A⊥Z, A⊥C1, A≮Z′, A lies in X-C1 plane
Z′∥Z, Z′⊥X, Z′ is in X-C1 plane

Also for this embodiment, further coordinate transformations are necessary compared to the first embodiment in order to get from a coordinate system defined by the machine axes X, Y, Z′, A, B, C1 into an orthogonal coordinate system or into a conventional coordinate system of the machine controller and vice versa. The corresponding transformations can again be easily derived by simple trigonometric considerations.

Modifications

In the examples discussed above, the inclination angle ψ is positive, i.e. the Z′ axis is inclined towards the positive X direction, away from the workpiece axis C1. However, this angle can also be negative. The mentioned transformations also remain valid in this situation. A negative tilt angle ψ can be particularly advantageous if the last finishing stroke is along the negative Z direction (i.e. from top to bottom in FIG. 2), because then the tool carrier 5 is moved along the negative X direction to generate the compensation movement, i.e. towards the workpiece. This is advantageous because in this way the radial machining forces counteract the compensation movement, resulting in defined force conditions in the components involved in generating the X movement.

The present invention is not limited to a concrete processing method. The advantages of the invention were explained above with reference to continuous generating grinding. However, the invention also shows its advantages in other gear manufacturing processes, including processes with a geometrically undefined cutting edge and processes with a geometrically defined cutting edge. Examples of such processes are discontinuous generating grinding, discontinuous or continuous profile grinding, gear honing, gear hobbing or hob peeling (gear skiving). The invention can be used for the production of both externally toothed workpieces and internally toothed workpieces. The invention is particularly advantageous in the fine machining (finishing) of pre-toothed workpieces, especially in hard fine machining.

The present invention is not limited to a concrete sequence of machine axes. Depending on the type of machine, it may, for example, also be advantageous to arrange the axial slide directly on the machine bed and to arrange the workpiece spindle on a radial slide in order to achieve radial infeed by moving the workpiece spindle.

The present invention is also not limited to a situation where the radial infeed direction X is perpendicular to the workpiece axis C1. For instance, in the third and fourth embodiments, the radial infeed direction X runs at an angle different from 90° to the workpiece axis C1. However, it is also advantageous in this situation if the axial guide direction Z′ is in a common plane with the radial infeed direction X and the workpiece axis C1.

Instead of two workpiece spindles, there can also be three or more workpiece spindles or only a single workpiece spindle. The at least one workpiece spindle does not need to be arranged on a movable workpiece carrier, but can be located directly on the machine bed. In other embodiments, the at least one workpiece spindle is arranged on a movable workpiece carrier, which realizes the radial infeed movement along the X direction. Also the A axis can be realized on the workpiece side instead of the tool side.

The dressing device 13 can be mounted on the machine bed instead of on a movable workpiece carrier. In this case, the tool carrier 5 can be configured to be pivoted relative to the machine bed to move the machining tool to the dressing tool, as known from e.g. U.S. Pat. No. 5,857,894B.

The above shows that a very large number of relative arrangements of the involved axes is possible. The invention is not limited to a concrete arrangement.

Furthermore, the present invention is not limited to certain types of drives for the various linear guides. The drive can be effected in any manner known in the prior art, e.g. by ball screw drives or linear motors.

1. A machine tool for the machining of gears, comprising:
a workpiece spindle to drive a workpiece for rotation about a workpiece axis;
a tool spindle to drive a tool for rotation about a tool axis,
an axial slide configured to vary a relative axial feed position between the tool spindle and the workpiece spindle with respect to the workpiece axis,
the axial slide being guided along an axial guide direction which is inclined relative to the workpiece axis by an angle of inclination, the angle of inclination having an absolute value between 0.1° and 30°, in particular between 0.5° and 30°.

2. The machine tool according to claim 1, comprising a infeed slide configured to vary a radial distance between the tool axis and the workpiece axis along a radial infeed direction, wherein the axial guide direction runs in a common plane with the workpiece axis and the radial infeed direction.

3. The machine tool according to claim 2, wherein the radial infeed direction runs at an angle of 60° to 120° to the workpiece axis.

4. The machine tool according to claim 2, comprising:
a machine bed,
wherein the infeed slide is guided on the machine bed so as to be displaceable along the radial infeed direction, forming a tool carrier; and
wherein the axial slide is guided on the infeed slide along the axial guide direction.

5. The machine tool according to claim 2,
wherein the tool spindle is pivotable about a swivel axis relative to the axial slide, and
wherein the swivel axis extends in a common plane with the workpiece axis and the radial infeed direction, with an angle to the radial infeed direction that has an absolute value between 0° and 30°.

6. The machine tool according to claim 5, wherein the tool spindle is displaceable relative to the axial slide along a shift direction running parallel to the tool axis, the shift direction running perpendicular to the swivel axis.

7. The machine tool according to claim 1, comprising a control device configured to control the machine tool to carry out simultaneous movements between the tool spindle and the workpiece spindle along the inclined axial guide direction and the radial infeed direction.

8. The machine tool according to claim 7, wherein the control device is configured to carry out the following method:
causing simultaneous movements between the tool spindle and the workpiece spindle along the inclined axial guide direction and a radial infeed direction while a tool clamped on the tool spindle is in machining engagement with the workpiece clamped on the workpiece spindle,
wherein the movement along the inclined axial guide direction is carried out at an axial guide speed and the movement along the radial infeed direction is performed at a radial infeed speed, and
wherein the radial infeed speed during the machining of each individual tooth flank does not fall below a predetermined threshold value.

9. The machine tool according to claim 8, wherein the control device is configured to control the radial infeed speed and the axial guide speed in such a manner that the radial infeed speed and the axial guide speed have a ratio that changes during the machining of the tooth flank.

10. The machine tool according to claim 8, wherein the control device is configured to control the radial infeed speed and the axial guide speed such that the radial infeed speed does not change its sign during the machining of a tooth flank, while a resulting movement between the tool spindle and the workpiece spindle along the radial infeed direction has a speed which changes its sign during the machining of the tooth flank.

11. The machine tool according to claim 7, wherein the control device comprises at least one of the following transformation devices:
a first transformation device for transforming position variables measured along the radial infeed direction and the inclined axial guide direction into transformed position variables along the radial infeed direction and an axial feed direction parallel to the workpiece axis; and
a second transformation device for transforming control commands for a movement of the tool spindle relative to the workpiece spindle along an axial feed direction parallel to the workpiece axis into transformed control commands for a simultaneous movement of the tool spindle along the inclined axial guide direction and the radial infeed direction.

12. The machine tool according to claim 7, comprising a dressing device with a dressing tool,
wherein the control device is configured to cause the tool to be dressed with the dressing tool while causing movements along the inclined axial guide direction.

13. The machine tool according to claim 12, wherein the control device is adapted to bring the tool spindle into a dressing orientation in which the tool axis is in or parallel to a plane which is spanned by the axial guide direction and the radial infeed direction.

14. The machine tool according to claim 13, wherein the dressing device comprises a dressing spindle which is configured to drive the dressing tool to rotate about a dressing spindle axis, and wherein the dressing spindle is pivotable about at least one dressing pivot axis, to bring the dressing tool into engagement with the tool when the tool spindle is in the dressing orientation.

15. The machine tool according to claim 1, wherein the machine tool is configured to carry out one of the following processes:
continuous generation grinding, discontinuous generation grinding, discontinuous or continuous profile grinding, gear honing, hobbing or hob peeling.

16. A method for machining tooth flanks of a workpiece with a machine tool according to claim 1, comprising:
carrying out simultaneous movements between the tool spindle and the workpiece spindle along the inclined axial guide direction and the radial infeed direction while a tool mounted on the tool spindle is in machining engagement with the workpiece mounted on the workpiece spindle,
wherein the movement along the inclined axial guide direction is carried out at an axial guide speed and the movement along the radial infeed direction is performed at a radial infeed speed.

17. The method according to claim 16, wherein the radial infeed speed has an absolute value which during the machining of each individual tooth flank does not fall below a predetermined threshold value.

18. The method according to claim 16, wherein the radial infeed speed and the axial guide speed have a ratio which changes during the machining of a tooth flank.

19. The method according to claim 18, wherein the radial infeed speed and the axial guide speed have a time-variable ratio such that the radial infeed speed does not change its sign during the machining of a tooth flank, while a resulting movement between the tool spindle and the workpiece spindle along the radial infeed direction has a speed which changes its sign during the machining of the tooth flanks

20. A method of dressing a tool for machining gears with a machine according to claim 1, comprising:
generating relative movements between the tool and a dressing device comprising a dressing tool along the inclined axial guide direction while the tool is engaged with the dressing tool to dress the tool.

21. The method according to claim 20, wherein, before dressing, the tool spindle is brought into a dressing orientation in which the tool axis extends in or parallel to a plane which is spanned by the axial guide direction and the radial infeed direction.

22. The method according to claim 21,
wherein the dressing device comprises a dressing spindle configured to drive the dressing tool for rotation about a dressing spindle axis, and
wherein the method comprises:
swiveling the dressing spindle about at least one dressing pivot axis in order to bring the dressing tool into engagement with the tool when the tool spindle is in the dressing orientation.

23. The method according to claim 16, comprising:
measuring position variables along the radial infeed direction and the inclined axial guide direction; and
transforming the measured position variables into transformed position variables along the radial infeed direction and an axial feed direction running parallel to the workpiece axis.

24. The method according to claim 16, comprising:
generating control commands for a movement of the tool spindle relative to the workpiece spindle along an axial feed direction running parallel to the workpiece axis; and
transforming the generated control commands into transformed control commands for simultaneous movement of the tool spindle along the inclined axial guide direction and the radial infeed direction.

25. The method according to claim 16, said method consisting of one of the following methods: continuous generation grinding, discontinuous generation grinding, discontinuous or continuous profile grinding, gear honing, hobbing or hob peeling.

26. A non-volatile computer-readable medium on which a computer program is stored, the computer program comprising instructions which cause a control device of a machine tool according to claim 1 to carry out a method comprising:
carrying out simultaneous movements between the tool spindle and the workpiece spindle along the inclined axial guide direction and the radial infeed direction while a tool mounted on the tool spindle is in machining engagement with the workpiece mounted on the workpiece spindle, wherein the movement along the inclined axial guide direction is carried out at an axial guide speed and the movement along the radial infeed direction is performed at a radial infeed speed.

27. (canceled)

28. The machine tool according to claim 2, wherein the radial infeed direction is perpendicular to the workpiece axis.

29. The machine tool according to claim 5, wherein the swivel axis is parallel to the radial infeed direction.

30. The machine tool according to claim 14, wherein the dressing pivot axis extends at an angle of 60° to 120° to the axial feed direction.

31. The method according to claim 22, wherein the dressing pivot axis extends at an angle of 60° to 120° to the axial feed direction.
